(19) United States
(12) Patent Application Publication
(10) Pub. No.: US 2014/0314048 A1
(43) Pub. Date: Oct. 23, 2014

(54) CONNECTION ESTABLISHMENT METHOD AND APPARATUS FOR MTC UE

(71) Applicant: LG ELECTRONICS INC., Seoul (KR)

(72) Inventors: Yun Jung Yi, Anyang-si (KR); Joon Kui Ahn, Anyang-si (KR); Suck Chel Yang, Anyang-si (KR)

(73) Assignee: LG ELECTRONICS INC., Seoul (KR)

(21) Appl. No.: 13/989,747

(22) PCT Filed: Jan. 1, 2013
(86) PCT No.: PCT/KR2013/000775

§ 371 Date: May 24, 2013

Related U.S. Application Data
(60) Provisional application No. 61/592,516, filed on Jan. 30, 2012.

(51) Int. Cl. H04W 4/00; H04W 76/02; H04W 36/00

(52) U.S. Cl. CPC H04W 4/005; H04W 36/0072; H04W 76/02
USPC 370/332; 370/331

(57) ABSTRACT

A connection establishment method for a Machine Type Communication (MTC) User Equipment (UE) in a wireless communication system is provided. A MTC UE receives system information from at least one neighbor Base Station (BS). The system information includes information regarding whether or not the at least one BS supports MTC UE. The MTC UE determines at least one candidate BS based on the system information. The at least one candidate BS supports the MTC UE. The MTC UE determines a last BS based on an intensity of a signal from the at least one candidate BS. The MTC UE sends a random access preamble to the last BS.

### TECHNICAL FIELD

The present invention relates to wireless communication and, more particularly, to a connection establishment method for Machine Type Communication (MTC) User Equipment (UE) and an apparatus using the same.

### BACKGROUND ART

With the development of wireless communication technology, various types of wireless communication systems other than common communication between a user and a base station appear.

Machine Type Communication (MTC) is one type of data communication including one or more entities that do not require an interaction with a human being. That is, MTC refers to a concept in which not User Equipment (UE) used by a human being, but a machine apparatus performs communication over a network.

The features of MTC UE are different from those of common UE. First, the number of pieces of MTC UE covered by a base station is much larger than that of pieces of common UE. The number of pieces of MTC UE covered by one base station can be hundreds to several thousands. Second, the size of data transmitted or received by MTC UE are much smaller than that by common UE. Furthermore, the type of the data is limited.

Meanwhile, 3^{rd} Generation Partnership Project (3GPP) Long Term Evolution (LTE) is an improved type of a Universal Mobile Telecommunication System (UMTS) and introduced as 3GPP release 8. 3GPP LTE uses Orthogonal Frequency Division Multiple Access (OFDMA) in downlink and uses Single Carrier-Frequency Division Multiple Access (SC-FDMA) in uplink. 3GPP LTE-advanced (LTE-A), that is, an evolved type of 3GPP LTE, is recently being discussed.

Cell searches and connection establishment in an LTE system and an LTE-A system are performed based on Primary Synchronization Signal (PSS)/Secondary Synchronization Signal (SSS) and random access. A conventional cell search and connection establishment procedure defined in the LTE system and the LTE-A system is performed based on common UE. MTC UE is expected to have lower specifications than common UE, so a cell search and connection establishment procedure for MTC UE need to be newly defined.

### DISCLOSURE

### Technical Problem

An object of the present invention is to provide a cell search method for Machine Type Communication (MTC) User Equipment (UE) and UE operating in a limited coverage and an apparatus using the same.

Another object of the present invention is to provide a connection establishment method for MTC UE and UE operating in a limited coverage and an apparatus using the same.

### Technical Solution

In an aspect, a connection establishment method for a Machine Type Communication (MTC) User Equipment (UE) in a wireless communication system is provided. The method comprises steps of: a MTC UE receiving system information from at least one neighbor Base Station (BS), the MTC UE determining at least one candidate BS based on the system information, the MTC UE determining a last BS based on an intensity of a signal from the at least one candidate BS, and the MTC UE sending a random access preamble to the last BS. The system information includes information regarding whether or not the at least one BS supports MTC UE. The at least one candidate BS supports the MTC UE.

The system information may include an MTC subframe pattern index indicative of a subframe in which the random access preamble is transmitted.

The random access preamble may be an MTC-dedicated preamble. The random access preamble may be transmitted in a bandwidth narrower than a bandwidth in which the system information is received. The system information may be received in a bandwidth of 20 MHz, and the random access preamble may be transmitted in a bandwidth narrower than 20 MHz.

The system information may be received via a physical broadcast channel (PBCH), and the random access preamble may be transmitted via a physical random access channel (PRACH).

The last BS may be a BS having a strongest intensity of a signal, from among the at least one candidate BS.

The last BS may be a BS first searched for from among the at least one candidate BS in each of which the intensity of the signal is greater than a predetermined threshold.

In another aspect, a Machine Type Communication (MTC) User Equipment (UE) in a wireless communication system is provided. The UE comprises a Radio Frequency (RF) unit configured to transmit and receive radio signals and a processor connected to the RF unit. The processor is configured to: receive system information from at least one neighbor Base Station (BS), determine at least one candidate BS based on the system information, determine a last BS based on an intensity of a signal from the at least one candidate BS, and send a random access preamble to the last BS. The system information includes information regarding whether or not the at least one BS supports MTC UE. The at least one candidate BS supports the MTC UE.

### Advantageous Effects

Machine Type Communication (MTC) UE having low specifications can efficiently perform cell searches and connection establishment.

The power of MTC UE can be saved.

### DESCRIPTION OF DRAWINGS

FIG. 1 shows the structure of a radio frame in 3GPP LTE.

FIG. 2 shows an example of a resource grid for one downlink slot.

FIG. 3 shows the structure of a downlink subframe.

FIG. 4 shows an example in which a reference signal and a control channel in a DL subframe of 3GPP LTE.

FIG. 5 shows an example of a subframe having an enhanced Physical Downlink Control Channel (ePDCCH).

FIG. 6 shows the structure of an uplink subframe.

FIG. 7 shows an example of the structure of a subframe of a single carrier system and a carrier aggregation system.

FIG. 8 shows an example of the structure of a subframe of a 3GPP LTE-A system in which cross-carrier scheduling is performed by using a CIF.

FIG. 9 is a flowchart illustrating a random access procedure in 3GPP LTE.

FIG. 10 shows an example of a random access response.

FIG. 11 shows a neighbor cell search and connection establishment scenario for MTC UE in accordance with an embodiment of the present invention.

FIG. 12 is a flowchart illustrating a connection establishment method for MTC UE in accordance with an embodiment of the present invention.

FIG. 13 is a block diagram of a wireless communication system in which the embodiments of the present invention are implemented.

### MODE FOR INVENTION

The following technologies can be used in a variety of wireless communication systems, such as Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA). CDMA can be implemented using radio technology, such as Universal Terrestrial Radio Access (UTRA) or CDMA2000. TDMA can be implemented using radio technology, such as Global System for Mobile communications (GSM)/General Packet Radio Service (GPRS)/Enhanced Data rates for GSM Evolution (EDGE). OFDMA can be implemented using radio technology, such as Institute of Electrical and Electronics Engineers (IEEE) 802.11 (Wi-Fi), IEEE 802.16 (WiMAX), IEEE 802.20, or Evolved UTRA (E-UTRA). IEEE 802.16m is the evolution of IEEE 802.16e, and it provides backward compatibility with systems based on IEEE 802.16e. UTRA is part of a Universal Mobile Telecommunications System (UMTS). 3^{rd} Generation Partnership Project (3GPP) Long Term Evolution (LTE) is part of an Evolved UMTS (E-UMTS) using evolved UMTS Terrestrial Radio Access (E-UTRA), and it adopts OFDMA in downlink and adopts SC-FDMA in uplink. LTE-Advanced (LTE-A) is the evolution of 3GPP LTE.

User Equipment (UE) can be fixed or mobile and can also be called another terminology, such as a Mobile Station (MS), a Mobile Terminal (MT), a User Terminal (UT), a Subscriber Station (SS), a wireless device, a Personal Digital Assistant (PDA), a wireless modem, or a handheld device.

A Base Station (BS) commonly refers to a fixed station communicating with UE. The BS can also be called another terminology, such as an evolved-NodeB (eNB), a Base Transceiver System (BTS), or an access point.

Hereinafter, the application of the present invention based on 3GPP LTE based on 3GPP release 8 is described. This application is illustrative, and the present invention can be applied to a variety of wireless communication networks. LTE hereinafter refers to LTE and/or LTE-A.

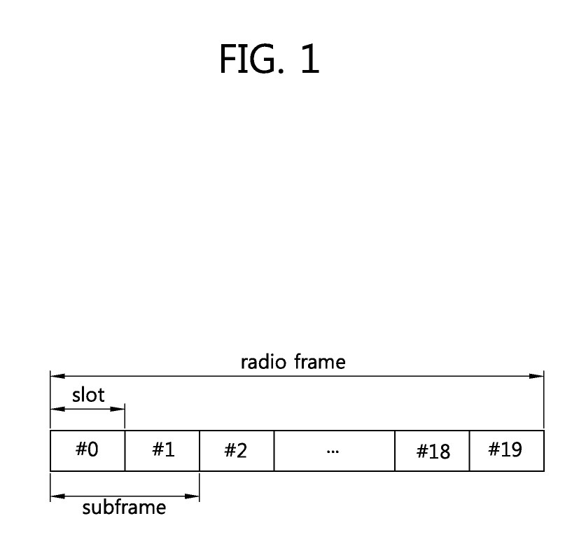

FIG. 1 shows the structure of a radio frame in 3GPP LTE.

For the structure, reference can be made to Section 5 of a 3^{rd} Generation Partnership Project (3GPP) TS 36.211 V10.3.0 (2011-09) “Technical Specification Group Radio Access Network; Evolved Universal Terrestrial Radio Access (E-UTRA); Physical channels and modulation (Release 10)”.

Referring to FIG. 1, the radio frame includes 10 subframes. One subframe includes two contiguous slots. The slots within the radio frame are assigned slot numbers #0 to #19. The time that is taken to send one subframe is called a Transmission Time Interval (TTI). The TTI may be a scheduling unit for data transmission. For example, the length of one radio frame may be 10 ms, the length of one subframe may be 1 ms, and the length of one slot may be 0.5 ms.

One slot includes a plurality of Orthogonal Frequency Division Multiplexing (OFDM) symbols in a time domain and includes a plurality of subcarriers in a frequency domain. The OFDM symbol is for representing one symbol period because 3GPP LTE uses OFDMA in downlink and may be called another terminology depending on multiple access methods. For example, if SC-FDMA is used as an uplink multiple access scheme, an OFDM symbol may be called an SC-FDMA symbol. A Resource Block (RB) is a resource allocation unit, and the RB includes a plurality of contiguous subcarriers in one slot.

The structure of the radio frame shown in FIG. 1 is only an example. Accordingly, the number of subframes included in a radio frame, the number of slots included in a subframe, or the number of OFDM symbols included in a slot can be changed in various ways. In 3GPP LTE, one slot is defined to include 7 OFDM symbols in a normal Cyclic Prefix (CP), and one slot is defined to include 6 OFDM symbols in an extended CP.

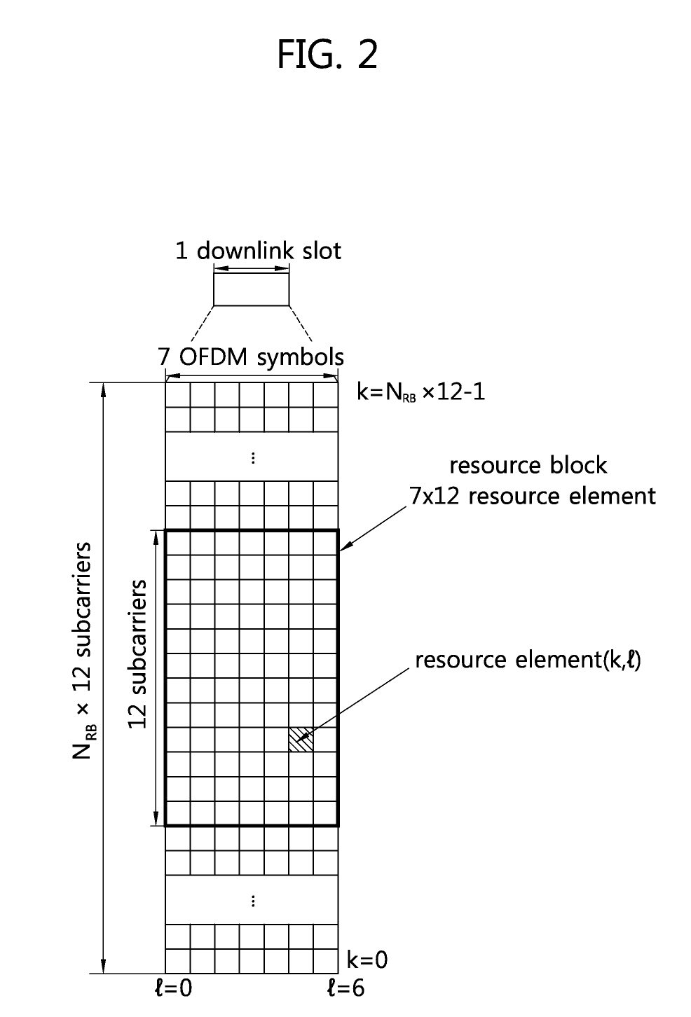

FIG. 2 shows an example of a resource grid for one downlink slot.

The downlink slot includes a plurality of OFDM symbols in a time domain and includes an N_{RB} number of RBs in a frequency domain. The number of RBs N_{RB} included in a downlink slot depends on a downlink transmission bandwidth configured in a cell. For example, in an LTE system, the number of RBs N_{RB} may be any one of 6 to 110. One RB includes a plurality of subcarriers in a frequency domain. An uplink slot may have the same structure as the downlink slot.

Each element on a resource grid is referred to as a Resource Element (RE). The RE on the resource grid can be identified by an index pair (k,l) within a slot. Here, k (k=0, . . . , N_{RB}×12-1) is a subcarrier index within a frequency domain, and 1 (1=0, . . . , 6) is an OFDM symbol index within a time domain.

In the present invention, one RB is illustrated as including 7×12 REs, including 7 OFDM symbols in a time domain and 12 subcarriers in a frequency domain, but the number of OFDM symbols and the number of subcarriers within an RB are not limited thereto. The number of OFDM symbols and the number of subcarriers can be changed in various ways depending on the length of a CP, frequency spacing, etc.

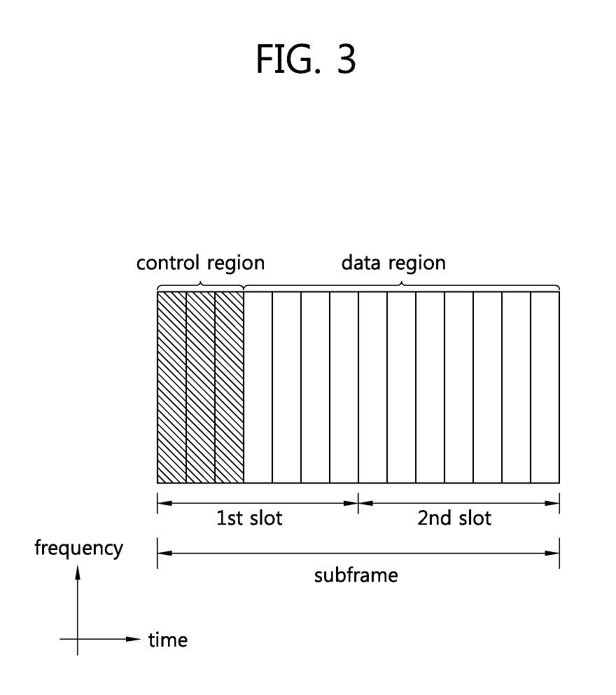

FIG. 3 shows the structure of a downlink subframe.

The downlink (DL) subframe is divided into a control region and a data region in a time domain. The control region includes a maximum of former 3 OFDM symbols in a first slot within the DL subframe, but the number of OFDM symbols included in the control region may be changed. Control channels different from a physical downlink control channel (PDCCH) are allocated to the control region, and PDSCHs are allocated to the data region.

Control information transmitted through a PDCCH is called Downlink Control Information (DCI). DCI can include information about the resource allocation of a PDSCH (this is also called a DL grant), the resource allocation of a PUSCH (this is also called an UL grant), a set of transmit power control commands for each UE within a specific UE group, and/or the activation of a Voice over Internet Protocol (VoIP).

A BS determines a PDCCH format based on DCI to be transmitted to UE, attaches a Cyclic Redundancy Check (CRC) to the DCI, and masks a unique identifier (this is also called a Radio Network Temporary Identifier (RNTI)) the CRC depending on the owner or use of a PDCCH.

If the PDCCH is a PDCCH for specific UE, an identifier unique to the UE, for example, a Cell-RNTI (C-RNTI) can be masked to the CRC. If the PDCCH is a PDCCH for a paging message, a paging instruction identifier, for example, a Paging-RNTI (P-RNTI) can be masked to the CRC. If the PDCCH is a PDCCH for a System Information Block (SIB), a system information identifier, for example, a System Information-RNTI (SI-RNTI) can be masked to the CRC. A Random Access-RNTI (RA-RNTI) can be masked to the CRC in order to indicate a random access response, that is, a response to the transmission of a random access preamble. A Transmit Power Control-RNTI (TPC-RNTI) is masked to the CRC in order to indicate a TPC order for a plurality of UEs.

A control region within a subframe includes a plurality of Control Channel Elements (CCEs). The CCE is a logical allocation unit used to provide a PDCCH with a coding rate depending on the state of a radio channel, and corresponds to a plurality of Resource Element Groups (REGs). The REG includes a plurality of REs. The format of a PDCCH and the number of bits of an available PDCCH are determined depending on association between the number of CCEs and a coding rate provided by the CCEs.

One REG includes 4 REs, and one CCE includes 9 REGs. In order to configure one PDCCH, {1, 2, 4, 8} CCEs may be used. Each of the elements of {1, 2, 4, 8} is called a CCE aggregation level.

The number of CCEs used for transmission of a PDDCH is determined by a BS depending on a channel condition. For example, UE having a good DL channel condition may use one CCE for transmission of a PDCCH. UE having a poor DL channel condition may use 8 CCEs for transmission of a PDCCH.

A control channel including one or more CCEs is mapped to physical resources, after interleaving is performed in unit of an REG and cyclic shift based on a cell identifier (ID) is then performed.

Meanwhile, UE is unable to know that its own PDCCH is transmitted using what CCE aggregation level or what DCI format in which place within a control region. Since a plurality of PDCCHs can be transmitted within one subframe, UE monitors the plurality of PDCCHs for every subframe. Here, the term ‘monitoring’ means that the UE attempts to decode the PDCCH depending on a PDCCH format.

In 3GPP LTE, in order to reduce a load resulting from blind decoding, a search space is used. The search space may be called a monitoring set of CCEs for a PDCCH. UE monitors a PDCCH within a search space.

A search space is classified into a common search space and a UE-specific search space. The common search space is a space where a PDCCH having common control information is searched for. The common search space includes 16 CCEs having a CCE index 0 to a CCE index 15 and supports a PDCCH having a {4, 8} CCE aggregation level. However, a PDCCH (DCI formats 0 and 1A) that carries UE-specific information may also be transmitted in the common search space. The UE-specific search space supports a PDCCH having a {1, 2, 4, 8} CCE aggregation level.

Table 1 below indicates the number of PDCCH candidates monitored by UE.

TABLE 1

| Search Space | Aggregation | Size [in | Number of PDCCH | |
|---|---|---|---|---|
| Type | level L | CCEs] | candidates | DCI formats |
| UE-specific | 1 | 6 | 6 | 0, 1, 1A, 1B, |
| | 2 | 12 | 6 | 1D, 2, 2A |
| | 4 | 8 | 2 | |
| | 8 | 16 | 2 | |
| Common | 4 | 16 | 4 | 0, 1A, 1C, |
| | 8 | 16 | 2 | 3/3A |

The size of a search space is determined by Table 1, and the starting position of the search space is differently defined in a common search space and a UE-specific search space. A starting position of the common search space is fixed irrespective of a subframe, whereas a starting position of the UE-specific search space can be different in each subframe depending on a UE identifier (e.g., C-RNTI), a CCE aggregation level and/or a slot number within a radio frame. If the starting position of a UE-specific search space is within a common search space, the UE-specific search space and the common search space may overlap with each other.

In an aggregation level Lε{1,2,4,8}, a search space S^{(L)}ₖ is defined as a set of PDCCH candidates. A CCE corresponding to the PDCCH candidates m of the search space S^{(L)}ₖ is given as follows.

L·{(Yₖ+m′)mod └N_{CCE,k}/L┘}+i [Equation 1]

In Equation 1, i=0, 1, . . . , L−1, m=0, . . . , M^{(L)}−1, and N_{CCE,k} is a total number of CCEs that can be used for transmission of a PDCCH within a control region of a subframe k. The control region includes a set of CCEs numbered from 0 to N_{CCE,k}−1. M^{(L)} is the number of PDCCH candidates in a CCE aggregation level L in a given search space.

If a Carrier Indicator Field (CIF) is configured for UE, m′=m+M^{(L)}n_{cif}. n_{cif} is a value of the CIF. If a CIF is not configured for UE, m′=m.

In a common search space, Yₖ is set to 2 aggregation levels and is configured as 0 when L=4 and L=8.

In a UE-specific search space having an aggregation level L, a parameter Yₖ is defined as follows.

Yₖ=(A·Yₖ₋₁)mod D [Equation 2]

In Equation 2, Y₋₁=n_{RNTI}≠0, A=39827, D=65537, k=floor (nₛ/2), and nₛ is a slot number within a radio frame.

When UE monitors a PDCCH based on a C-RNTI, a DCI format and a search space to be monitored are determined depending on transmission mode of a PDSCH. The following table shows an example of the PDCCH monitoring for which a C-RNTI is configured.

TABLE 2

| Trans- | | | Transmission scheme of |
|---|---|---|---|
| mission | DCI | | PDSCH corresponding to |
| mode | format | Search Space | PDCCH |
| Mode 1 | DCI | Common and | Single-antenna port, port 0 |
| | format 1A | UE specific | |
| | | by C-RNTI | |
| | DCI | UE specific | Single-antenna port, port 0 |
| | format 1 | by C-RNTI | |
| Mode 2 | DCI | Common and | Transmit diversity |
| | format 1A | UE specific | |
| | | by C-RNTI | |
| | DCI | UE specific | Transmit diversity |
| | format 1 | by C-RNTI | |
| Mode 3 | DCI | Common and | Transmit diversity |
| | format 1A | UE specific | |
| | | by C-RNTI | |
| | DCI | UE specific | Cyclic Delay Diversity (CDD) or |
| | format 2A | by C-RNTI | Transmit diversity |
| Mode 4 | DCI | Common and | Transmit diversity |
| | format 1A | UE specific | |
| | | by C-RNTI | |
| | DCI | UE specific | Closed-loop spatial multiplexing |
| | format 2 | by C-RNTI | |
| Mode 5 | DCI | Common and | Transmit diversity |
| | format 1A | UE specific | |
| | | by C-RNTI | |
| | DCI | UE specific | Multi-user Multiple Input Multiple |
| | format 1D | by C-RNTI | Output (MU-MIMO) |
| Mode 6 | DCI | Common and | Transmit diversity |
| | format 1A | UE specific | |
| | | by C-RNTI | |
| | DCI | UE specific | Closed-loop spatial multiplexing |
| | format 1B | by C-RNTI | using a single transmission layer |
| Mode 7 | DCI | Common and | If the number of PBCH antenna |
| | format 1A | UE specific | ports is one, Single-antenna port, |
| | | by C-RNTI | port 0 is used, otherwise Transmit |
| | | | diversity |
| | DCI | UE specific | Single-antenna port, port 5 |
| | format 1 | by C-RNTI | |
| Mode 8 | DCI | Common and | If the number of PBCH antenna |
| | format 1A | UE specific | ports is one, Single-antenna port, |
| | | by C-RNTI | port 0 is used, otherwise Transmit |
| | | | diversity |
| | DCI | UE specific | Dual layer transmission, port 7 |
| | format 2B | by C-RNTI | and 8 or single-antenna port, port |
| | | | 7 or 8 |

The use of a DCI format is classified as in the following table.

TABLE 3

| DCI format | Contents |
|---|---|
| DCI format 0 | Used for PUSCH scheduling |
| DCI format 1 | Used for the scheduling of one PDSCH codeword |
| DCI format 1A | Used for compact scheduling of one PDSCH codeword |
| | and a random access procedure |
| DCI format 1B | Used for compact scheduling of one PDSCH codeword |
| | having precoding information |
| DCI format 1C | Used for the very compact scheduling of one PDSCH |
| | codeword |
| DCI format 1D | Used for compact scheduling of one PDSCH codeword |
| | having precoding and power offset information |
| DCI format 2 | Used for PDSCH scheduling of UEs set in closed-loop |
| | spatial multiplexing mode |
| DCI format 2A | Used for PDSCH scheduling of UEs set in open-loop |
| | spatial multiplexing mode |
| DCI format 3 | Used for transmission of a TPC command for a PUCCH |
| | and a PUSCH having 2-bit power adjustments |
| DCI format 3A | Used for transmission of a TPC command for a PUCCH |
| | and a PUSCH having 1-bit power adjustment |

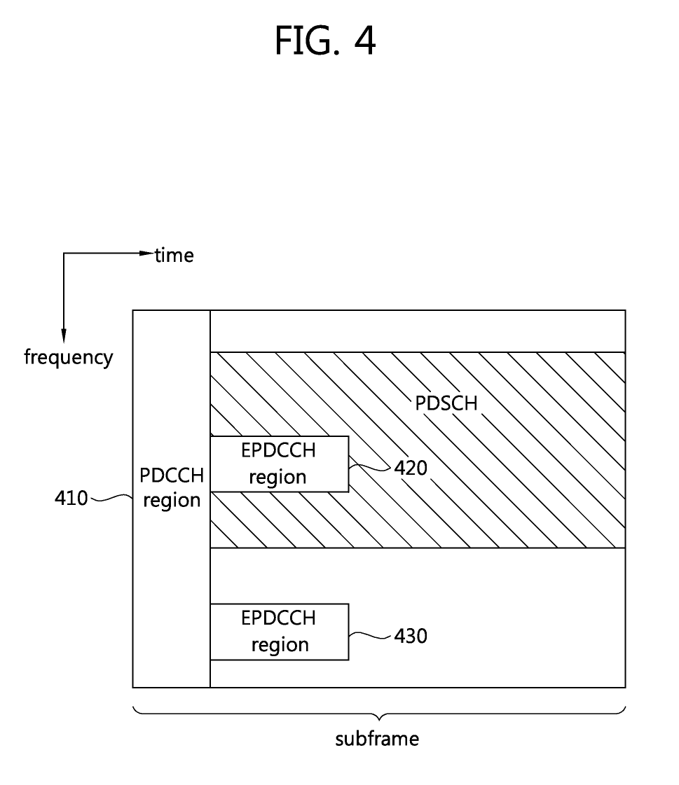

FIG. 4 shows an example in which a reference signal and a control channel in a DL subframe of 3GPP LTE.

A control region includes former 3 OFDM symbols, and a data region in which a PDSCH is transmitted includes the remaining OFDM symbols.

A Physical Control Format Indicator Channel, a Physical Hybrid-ARQ Indicator Channel and/or a PDCCH are transmitted in the control region. The CFI of the PCFICH indicates the 3 OFDM symbols. A region other than resources through which the PCFICH and/or the PHICH within the control region are transmitted becomes a PDCCH region in which a PDCCH is monitored.

A Physical Control Format Indicator Channel (PCFICH), a Physical Hybrid-ARQ Indicator Channel (PHICH) and/or a PDCCH are transmitted in the control region. The CFI of the PCFICH indicates the 3 OFDM symbols. A region other than resources through which the PCFICH and/or the PHICH within the control region are transmitted becomes a PDCCH region in which a PDCCH is monitored.

Various types of reference signals are also transmitted in the subframe.

A Cell-specific Reference Signal (CRS) can be received all pieces of UEs within a cell and is transmitted over the entire DL band. In FIG. 4, ‘R0’ is a Resource Element (RE) in which a CRS for a first antenna port is transmitted, ‘R1’ is an RE in which a CRS for a second antenna port is transmitted, ‘R2’ is an RE in which a CRS for a third antenna port is transmitted, and ‘R3’ is an RE in which a CRS for a fourth antenna port is transmitted.

An RS sequence r_{1,ns}(m) for a CRS is defined as follows.

$${r}_{l , ns} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad [ Equation 3 ]$$

In Equation 3, m=0, 1, . . . , 2N_{maxRB}−1, N_{maxRB} is a maximum number of RBs, ns is a slot number within a radio frame, and l is an OFDM symbol number within a slot.

A pseudo-random sequence c(i) is defined by the following Gold sequence having a length of 31.

c(n)=(x₁(n+Nc)+x₂(n+Nc))mod 2

x₁(n+31)=(x₁(n+3)+x₁(n))mod 2

x₂(n+31)=(x₂(n+3)+x₂(n+2)+x₂(n+1)+x₂(n))mod 2 [Equation 4]

In Equation 4, Nc=1600, and a first m-sequence is initialized to x₁(0)=1, x₁(n)=0, m=1, 2, . . . , 30.

A second m-sequence is initialized to cᵢₙᵢₜ=2¹⁰(7(ns+1)+l+1)(2N^{cell}_{ID}+1)+2N^{cell}_{ID}+N_{CP} at the start of each OFDM symbol N^{cell}_{ID} is the Physical Cell Identity (PCI) of a cell. N_{CP}=1 in a normal CP, and N_{CP}=0 in an extended CP.

Furthermore, a UE-specific Reference Signal (URS) can be transmitted. A CRS is transmitted in the entire region of a subframe, whereas an URS is transmitted within the data region of a subframe and used to demodulate a corresponding PDSCH. In FIG. 4, ‘R5’ indicates an RE in which an URS is transmitted. The URS is also called a Dedicated Reference Signal (DRS) or a Demodulation Reference Signal (DM-RS).

The URS is transmitted only in an RB to which a corresponding PDSCH is mapped. In FIG. 4, although R5 is indicated in regions other than a region in which a PDSCH is transmitted, this is for indicating the location of an RE to which an URS is mapped.

The URS is used by only UE that receives a corresponding PDSCH. An RS sequence rₙₛ(m) for UE is given in Equation 3. Here, m=0, 1, . . . , 12N_{PDSCH,RB}−1, and N_{PDSCH,RB} is the number of RBs used for corresponding PDSCH transmission. A pseudo-random sequence generator is initialized to cᵢₙᵢₜ=(floor(ns/2)+1)(2N^{cell}_{ID}+1)2¹⁶+n_{RNTI} at the start of each subframe. n_{RNTI} is the identifier of UE.

An URS can be transmitted through a single antenna, but may be transmitted through multiple antennas. If an URS is transmitted through multiple antennas, a pseudo-random sequence generator is initialized to cᵢₙᵢₜ=(floor(ns/2)+1)(2N^{cell}_{ID}+1)2¹⁶+n_{SCID} at the start of each subframe. n_{SCID} is a parameter obtained from a DL grant (e.g., DCI format 2B or 2C) related to PDSCH transmission.

An URS supports Multiple Input Multiple Output (MIMO) transmission. An RS sequence for an URS can be spread as the following spread sequence depending on an antenna port or a layer.

TABLE 4

| Layer | [w(0) w(1) w(2) w(3)] |
|---|---|
| 1 | [+1 +1 +1 +1] |
| 2 | [+1 −1 +1 −1] |
| 3 | [+1 +1 +1 +1] |
| 4 | [+1 −1 +1 −1] |
| 5 | [+1 +1 −1 −1] |
| 6 | [−1 −1 +1 +1] |
| 7 | [+1 −1 −1 +1] |
| 8 | [−1 +1 +1 −1] |

A layer can be defined as an information path to a precoder. A rank is the number of non-zero eigenvalues of an MIMIO channel matrix and is equal to the number of layers or the number of spatial streams. A layer can correspond to an antenna port for classifying URSs and/or a spread sequence applied to an URS.

Meanwhile, a PDCCH is monitored in a limited region called a control region within a subframe, and a CRS transmitted in entire band is used to demodulate the PDCCH. As the type of control information is diversified and the amount of control information is increased, the flexibility of scheduling using only an existing PDCCH is low. Furthermore, in order to reduce a load due to CRS transmission, an enhanced physical downlink control channel (ePDCCH) is being introduced.

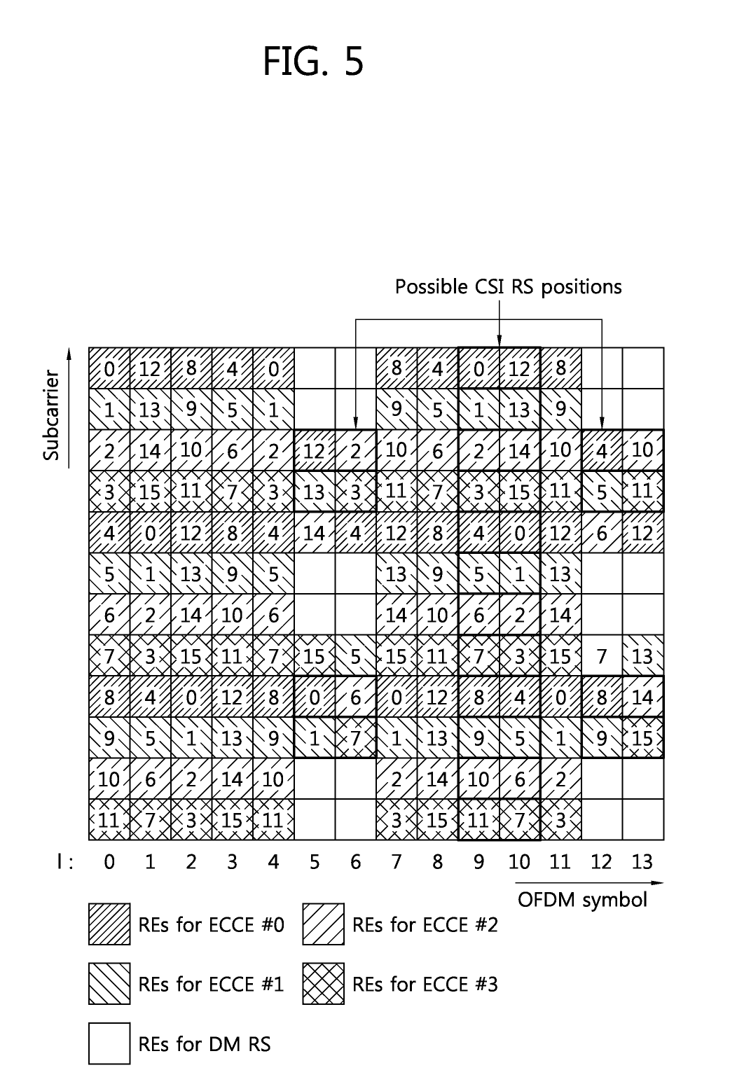

FIG. 5 shows an example of a subframe having an enhanced Physical Downlink Control Channel (ePDCCH).

The subframe can include 0 or one PDCCH region 410 and 0 or more ePDCCH regions 420 and 430.

UE monitors an ePDCCH in the ePDCCH regions 420 and 430. The PDCCH region 410 is located within former 4 OFDM symbols within a subframe, whereas the ePDCCH regions 420 and 430 can be flexibly scheduled in OFDM symbols after the PDCCH region 410.

One or more ePDCCH regions 420 and 430 may be assigned to UE, and the UE can monitor an ePDCCH in the assigned ePDCCH regions 420 and 430.

A BS can inform UE of information about the number/position/size of the ePDCCH regions 420 and 430 and/or a subframe in which an ePDCCH will be monitored through an RRC message.

In the PDCCH region 410, a PDCCH can be demodulated based on a CRS. In the ePDCCH regions 420 and 430, a demodulation (DM) RS not a CRS can be defined in order to demodulate an ePDCCH. An associated DM RS can be transmitted in corresponding ePDCCH regions 420 and 430.

An RS sequence rₙₛ(m) for the associated DM RS is the same as Equation 3. Here, m=0, 1, . . . , 12N_{RB}−1, and N_{RB} is a maximum number of RBs. A pseudo-random sequence generator can be initialized to cᵢₙᵢₜ=(floor(ns/2)+1)(2N_{ePDCCH,ID}+1)2¹⁶+n_{ePDCCH,SCID} at the start of each subframe. ns is a slot number within a radio frame, N_{ePDCCH,ID} is a cell index related to a corresponding ePDCCH region, and n_{ePDCCH,SCID} is a parameter given from higher layer signaling.

Each of the ePDCCH regions 420 and 430 can be used in scheduling for a different cell. For example, an ePDCCH within the ePDCCH region 420 can carry scheduling information for a first cell, and an ePDCCH within the ePDCCH region 430 can carry scheduling information for a second cell.

When ePDCCHs are transmitted through multiple antennas in the ePDCCH regions 420 and 430, the same precoding as that of an ePDCCH can be applied to DM RSs within the ePDCCH regions 420 and 430.

As compared that a PDCCH uses a CCE as a transmission resource unit, a transmission resource unit for an ePDCCH is called an enhanced Control Channel Element (eCCE). An aggregation level can be defined as a resource unit for monitoring an ePDCCH. For example, assuming that 1 eCCE is a minimum resource for an ePDCCH, an aggregation level L={1, 2, 4, 8, 16} can be defined.

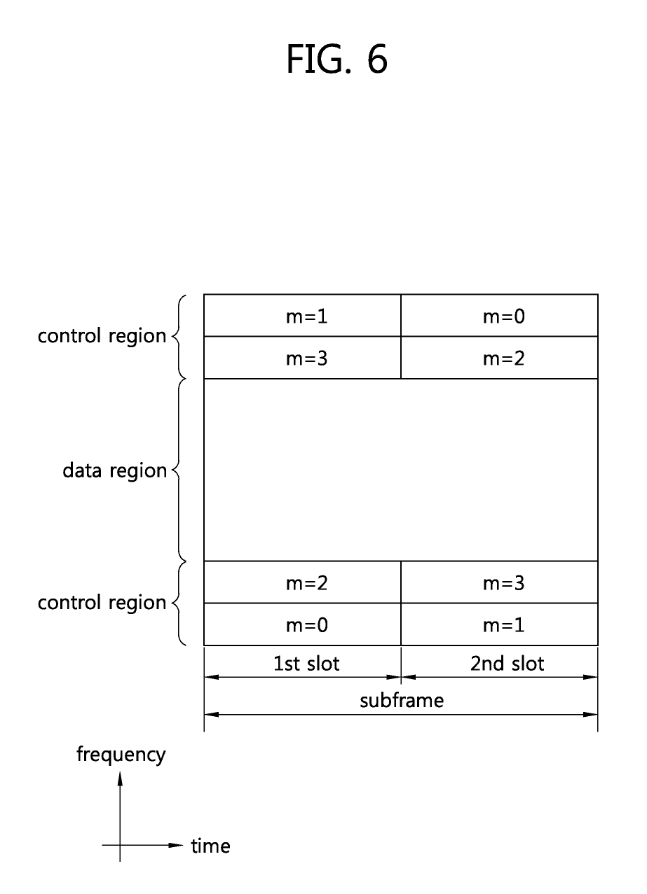

FIG. 6 shows the structure of an uplink subframe.

The uplink subframe can be divided into a control region and a data region in a frequency domain. A physical uplink control channel (PUCCH) in which UL control information is transmitted is allocated to the control region. A physical uplink shared channel (PUSCH) in which data is transmitted is allocated to the data region.

A PUCCH for each UE is allocated in the form of a Resource Block (RB) pair in a subframe. RBs belonging to an RB pair occupy different subcarriers in a first slot and a second slot, respectively. A frequency occupied by RBs that belong to an RB pair allocated to a PUCCH is changed on the basis of a slot boundary. This is said that the RB pair allocated to the PUCCH has been frequency-hopped in the slot boundary. UE can obtain a frequency diversity gain by transmitting UL control information through different subcarriers in accordance with time. m is a location index indicative of the location of a logical frequency domain of an RB pair allocated to a PUCCH within a subframe.

UL control information transmitted on a PUCCH includes a hybrid automatic repeat request (HARQ) acknowledgement (ACK), a Channel Quality Indicator (CQI) indicative of a DL channel condition, and a Scheduling Request (SR) indicative of an UL radio resource allocation request.

Meanwhile, as a need for a higher data throughput is increasing, a Carrier Aggregation (CA) supporting a plurality of cells can be used in 3GPP LTE-A. A CA may also be called another terminology, such as a bandwidth aggregation. A CA means that a wireless communication system configures a wideband by aggregating one or more carriers each having a smaller bandwidth than the target wideband in order to support the wideband. Target carriers for the one or more carriers may use a bandwidth used in an existing system without change for the purpose of backward compatibility with the existing system. For example, 3GPP LTE supports bandwidths 1.4 MHz, 3 MHz, 5 MHz, 10 MHz, 15 MHz, and 20 MHz, and 3GPP LTE-A can configure a wideband of 20 MHz or higher using only the bandwidths of a 3GPP LTE system. Or, a wideband may be configured by defining new bandwidths without using the bandwidths of an existing system.

A plurality of BSs and pieces of UE can communicate with one another through a maximum of 5 cells. The 5 cells can correspond to a maximum bandwidth of 100 MHz. That is, a CA environment indicates a case where specific UE has 2 or more configured serving cells (hereinafter referred to as ‘cells’) having different carrier frequencies. The carrier frequency indicates the center frequency of a cell.

A cell indicates a combination of DL resources and optional UL resources. That is, a cell must include DL resources and may optionally include UL resources combined with the DL resources. The DL resources may be DL Component Carriers (CCs). The UL resources can be UL CCs. If specific UE has one configured serving cell, the specific UE can have one DL CC and one UL CC. If specific UE has two or more cells, the specific UE may have the number of DL CCs equal to the number of cells and the number of UL CCs smaller than or equal to the number of cells. That is, if a CA is supported in current 3GPP LTE-A, the number of DL CCs may be always greater than or equal to the number of UL CCs. In releases after 3GPP LTE-A, however, a CA in which the number of DL CCs is smaller than the number of UL CCs may be supported.

Linkage between a carrier frequency of a DL CC and a carrier frequency of an UL CC can be indicated by system information transmitted on the DL CC. The system information can be System Information Block type2 (SIB2).

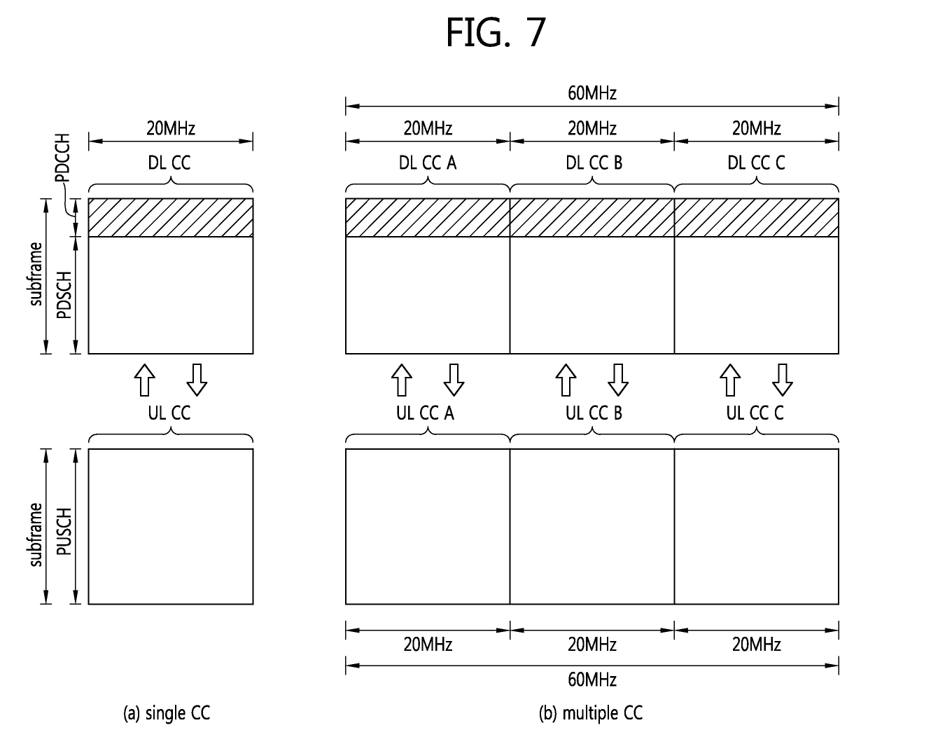

FIG. 7 shows an example of the structure of a subframe of a single carrier system and a CA system.

FIG. 7(a) shows a single carrier system. It is assumed that a system bandwidth of FIG. 7(a) is 20 MHz. Since the number of carriers is 1, each of the bandwidth of a DL CC transmitted by a BS and the bandwidth of an UL CC transmitted by UE is 20 MHz. The BS performs DL transmission through the DL CC, and the UE performs UL transmission through the UL CC.

FIG. 7(b) shows a CA system. It is assumed that a system bandwidth of FIG. 7(b) is 60 MHz. A DL bandwidth consists of a DL CC A, a DL CC B, and a DL CC C each having a bandwidth of 20 MHz. An UL bandwidth consists of an UL CC A, an UL CC B, and an UL CC C each having a bandwidth of 20 MHz. A BS performs DL transmission through the DL CC A, the DL CC B, and the DL CC C, and UE performs UL transmission through the UL CC A, the UL CC B, and the UL CC C. Each of the DL CCA and the UL CC A, the DL CCB and the UL CC B, and the DL CCC and the UL CC C can correspond to each other.

As a CA environment is introduced, cross-carrier scheduling can be applied. A PDCCH on a specific DL CC can schedule a PDSCH on any one of a plurality of DL CCs or schedule a PUSCH on any one of a plurality of UL CCs through cross-carrier scheduling. For the cross-carrier scheduling, a Carrier Indicator Field (CIF) can be defined. The CIF can be included in a DCI format transmitted on a PDCCH. Whether or not the CIF is present within a DCI format can be indicated by a higher layer semi-statically or UE-specifically. When cross-carrier scheduling is performed, the CIF can indicate a DL CC in which a PDSCH is scheduled or an UL CC in which a PUSCH is scheduled. The CIF may be fixed 3 bits and may be present at a fixed position irrespective of the size of a DCI format. If a CIF is not present in a DCI format, a PDCCH on a specific DL CC may schedule a PDSCH on the same DL CC or may schedule a PUSCH on an UL CC that is SIB2-connected to the specific DL CC.

If cross-carrier scheduling is performed using a CIF, a BS can allocate a PDCCH monitoring DL CC aggregation in order to reduce the complexity of blind decoding by UE. The PDCCH monitoring DL CC aggregation corresponds to some of all DL CCs, and the UE performs blind decoding on only a PDCC within the PDCCH monitoring DL CC aggregation. That is, in order to schedule a PDSCH and/or a PUSCH to UE, a BS can send a PDCCH through only DL CCs within a PDCCH monitoring DL CC aggregation. The PDCCH monitoring DL CC aggregation can be configured UE-specifically, UE group-specifically or cell-specifically.

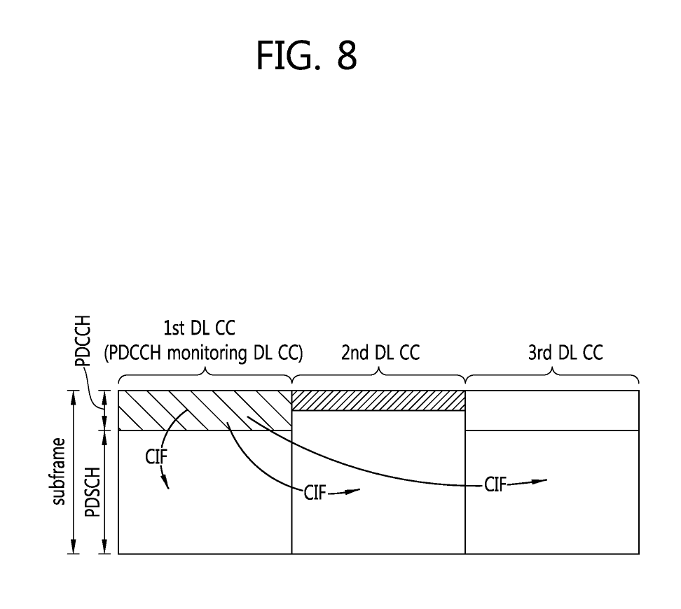

FIG. 8 shows an example of the structure of a subframe of a 3GPP LTE-A system that is subject to cross-carrier scheduling through a CIF.

Referring to FIG. 8, the first DL CC of three DL CCs is configured as a PDCCH monitoring DL CC. If cross-carrier scheduling is not performed, each DL CCs schedules a PDSCH by sending each PDCCH. If cross-carrier scheduling is performed, only the first DL CC configured as the PDCCH monitoring DL CC transmits a PDCCH. The PDCCH transmitted on the first DL CC schedules not only the PDSCH of the first DL CC, but also the PDSCHs of a second DL CC and a third DL CC by using a CIF. The second DL CC and the third DL CC not configured as a PDCCH monitoring DL CC do not transmit PDCCHs.

Furthermore, UE can transmit UL control information, such as Channel State Information (CSI) received, detected, or measured from one or more DL CCs or an ACK/NACK signal, to a BS through one predetermined UL CC. The CSI can include a CQI, a Precoding Matrix Indicator (PMI), a Rank Indicator (RI) and so on. For example, when UE needs to transmit ACK/NACK signals for data received from a plurality of DL CCs, the UE can multiplex or bundle the plurality of ACK/NACK signals for the data received from the respective DL CCs and transmit the multiplexed or bundled ACK/NACK signal to a BS through the PUCCH of one UL CC. A case where the transmission of an ACK/NACK signal for a DL CC is necessary in 3GPP LTE includes the following three cases.

1) An ACK/NACK signal for the transmission of a PDSCH indicated by a corresponding PDCCH in a subframe n-k can be transmitted in a subframe n. kεK, wherein K is M element sets {k₀, k₁, . . . , k_{M-1}} depending on the subframe n and an UL/DL configuration. This case corresponds to a case where an ACK/NACK signal for a common PDSCH is transmitted.

2) An ACK/NACK signal for the PDCCH of a subframe n-k indicative of the release of DL Semi-Persistent Scheduling (SPS) can be transmitted in a subframe n. kεK, wherein K is M element sets {k0, k1, . . . , k_{M-1}} depending on the subframe n and an UL/DL configuration. An ACK/NACK signal for a PDCCH indicative of the activation of the DL SPS is not transmitted.

3) An ACK/NACK signal for the transmission of a PDSCH without a corresponding PDCCH in a subframe n-k can be transmitted in a subframe n. kεK, wherein K is M element sets {k₀, k₁, . . . ,k_{M-1}} depending on the subframe n and an UL/DL configuration. This case corresponds to a case where an ACK/NACK signal for DL SPS is transmitted.

In the above description, K is called a bundling window. That is, the bundling window refers to one or more DL subframes corresponding to an ACK/NACK signal in one UL subframe. In an FDD system, M=1 and K={ k0}={ 4}.

Meanwhile, with the development of wireless communication technology, various types of wireless communication systems other than common communication between a user and a BS are emerging.

Machine Type Communication (MTC) is one type of data communication including one or more entities that do not require an interaction with a human being. That is, MTC refers to a concept in which not User Equipment (UE) used by a human being, but a machine apparatus performs communication over a network. A machine apparatus used in MTC is called MTC UE.

The features of MTC UE are different from those of common UE. For example, the MTC UE has the following features.

(1) Once deployed, MTC UE directly performs communication with a BS without an interaction with a human being. Accordingly, a communication pattern of the MTC UE can be predicted and is more static than that of communication between a user and a BS.

(2) An activation communication period in which MTC UE and a BS exchange data is rarely present. Furthermore, the size of data exchanged between MTC UE and a BS within an activation communication period is very small, and the type of data is also limited.

(3) MTC UE has a limited use of a battery. Accordingly, an efficient energy management mechanism is necessary.

(4) In general, MTC UE is fixedly deployed at one place and thus is not moved. A pattern in which MTC UE having mobility moves is previously determined.

Cell searches and connection establishment in an LTE system and an LTE-A system are performed based on a Primary Synchronization Signal (PSS)/Secondary Synchronization Signal (SSS) and random access. Existing cell search and connection establishment procedures defined in an LTE system and an LTE-A system are performed based on common UE. It may be ideal that MTC UE performs the same cell search mechanism as common UE in coexistence with the common UE, but the MTC UE is expected to have lower specifications than the common UE. Accordingly, the MTC UE may have a difficulty in performing the same cell search and connection establishment procedure as existing cell search and connection establishment procedure. Furthermore, since MTC UE has a limited use of a battery, it is important for the MTC UE to access a network using minimum energy when the MTC UE is powered on or the MTC UE returns from saving mode. Accordingly, it is necessary to newly define a cell search procedure and a connection establishment procedure for MTC UE.

MTC UE is chiefly described hereinafter for convenience of description, but a person having ordinary skill in the art to which the present invention pertains can readily apply the technical spirit of the present invention to common UE. For example, the technical spirit of the present invention can also be applied to UE having low specifications, such as UE having a narrower bandwidth through which data is transmitted than common UE or UE operating in a limited coverage.

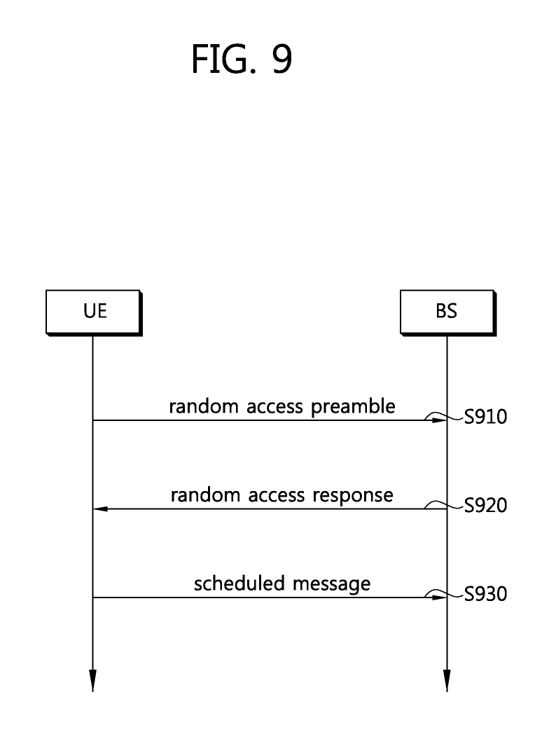

FIG. 9 is a flowchart illustrating a random access procedure in 3GPP LTE. The random access procedure is used for UE to obtain UL synchronization with a BS or to receive UL radio resources allocated thereto. RRC connection is initialized through the random access procedure.

UE receives a root index and a physical random access channel (PRACH) configuration index from a BS. 64 candidate random access preambles defined by a Zadoff-Chu (ZC) sequence are present in each cell, and the root index is a logical index used by the UE in order to generate the 64 candidate random access preambles.

The transmission of the random access preamble is limited to a specific time and frequency resources in each cell. The PRACH configuration index indicates a specific preamble format and a specific subframe in which the random access preamble can be transmitted.

The UE transmits a randomly selected random access preamble to the BS at step S910. The UE selects one of the 64 candidate random access preambles. The UE selects a corresponding subframe based on the PRACH configuration index. The UE transmits the selected random access preamble in the selected subframe.

In response to the random access preamble, the BS transmits a Random Access Response (RAR) to the UE at step S920. The random access response is detected through two steps. First, the UE detects a PDCCH masked as a Random Access-RNTI (RA-RNTI). Next, the UE receives a random access response within a Medium Access Control (MAC) Protocol Data Unit (PDU) on a PDSCH indicated by a DL grant on the detected PDCCH.

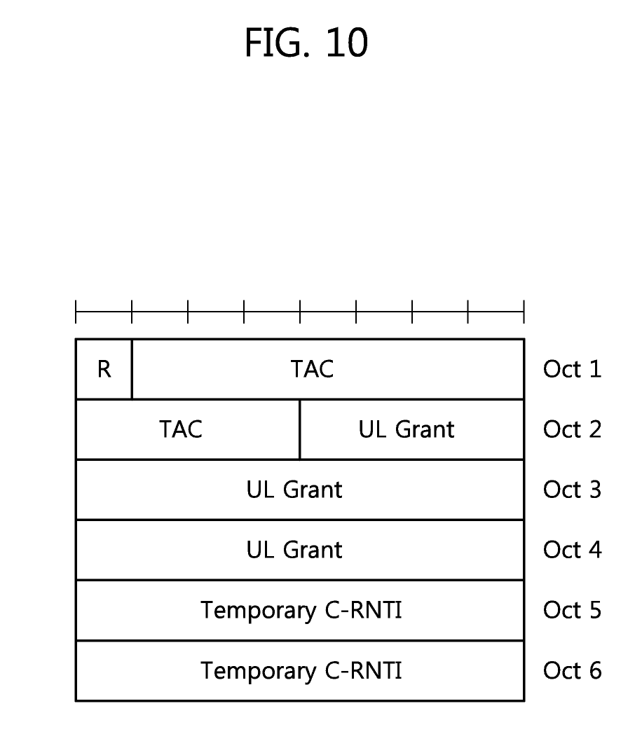

FIG. 10 shows an example of a random access response.

The random access response can include a Timing Advance Command (TAC), a UL grant, and a temporary C-RNTI.

The TAC is information about a timing alignment value sent from a BS to UE in order to maintain UL timing alignment. The UE updates UL transmission timing based on the timing alignment value. After the UL timing alignment is updated, the UE initiates or restarts a timing alignment timer. Only when the timing alignment timer operates, the UE can perform UL transmission.

An UL grant is UL resources used for transmission of a scheduling message.

Referring to back FIG. 9, the UE transmits a scheduled message to the BS in response to an UL grant within the random access response at step S930.

Meanwhile, as described above, the number of random access preamble sequences available in a current LTE system is limited. Accordingly, if the number of UEs trying to perform random access procedures is increased, there is a higher possibility that the random access procedure of the UEs may collide against each other. Accordingly, there is proposed a physical broadcast channel (PBCH) and a random access preamble for MTC UE so that the MTC UE does not affect the goodput, latency, and Quality of Service (QoS) of existing UE and MTC UE having lower specifications than common UE can efficiently perform a cell search procedure and an connection establishment procedure.

(1) Information Regarding Whether or not MTC UE is Supported is Included in a PBCH
For example, a BS informs system information through the PBCH. Here, the BS may inform information regarding whether or not the BS supports MTC UE through the PBCH.
For example, the BS may define a field indicating whether or not it supports MTC UE and send the field through the PBCH.
For example, the BS may transmit an MTC subframe pattern index through the PBCH. The MTC subframe pattern index is an index newly defined for MTC UE that does not comply with the cell connection procedure of LTE lease 8-10. The MTC UE transmits a random access preamble based on the MTC subframe pattern index. That is, the MTC subframe pattern index indicates a subframe in which the MTC UE transmits the random access preamble.
For another example, a BS may inform information regarding whether or not the BS supports MTC UE using a method of decoding a PBCH.
For example, the BS may broadcast an additional PBCH in addition to an existing PBCH. The additional PBCH can be transmitted in a resource region different from a resource region in which the existing PBCH is transmitted.
MTC UE may be configured to preferentially attempt connection to a cell which supports MTC UE or may be configured to attempt connection to only a cell which supports MTC UE.

(2) Use of a Dedicated Random Access Preamble for MTC UE
As described above, the number of random access preamble sequences available in an LTE system is limited. Accordingly, influence on existing UE can be reduced because the dedicated random access preamble for MTC UE is used.
Furthermore, if MTC UE has different capabilities from existing UE, it is preferred that a BS knows corresponding UE is MTC UE in order to provide suitable service to the MTC UE. The BS can know that the corresponding UE is MTC UE based on a received a dedicated random access preamble for the MTC UE.
The BS can determine whether or not to attempt connection to the MTC UE based on the received dedicated random access preamble for the MTC UE. The BS may determine whether or not to accept the request of the MTC UE depending on its capabilities.

(3) Other Methods
MTC UE may obtain information regarding whether or not a BS supports MTC UE based on signaling performed before the MTC UE obtains system information through a PBCH.
For example, a BS may change a period and/or a resource region in which a PSS/SSS are transmitted. MTC UE may determine whether or not a corresponding BS supports MTC UE based on a period and/or a resource region in which a PSS/SSS are detected, a cell ID obtained through the PSS/SSS or the like.
For example, a BS may change a periodic and/or a resource region in which a CRS/CSI-RS is transmitted. MTC UE may determine whether or not a corresponding BS supports MTC UE based on a period and/or a resource region in which a CRS/CSI-RS is detected.

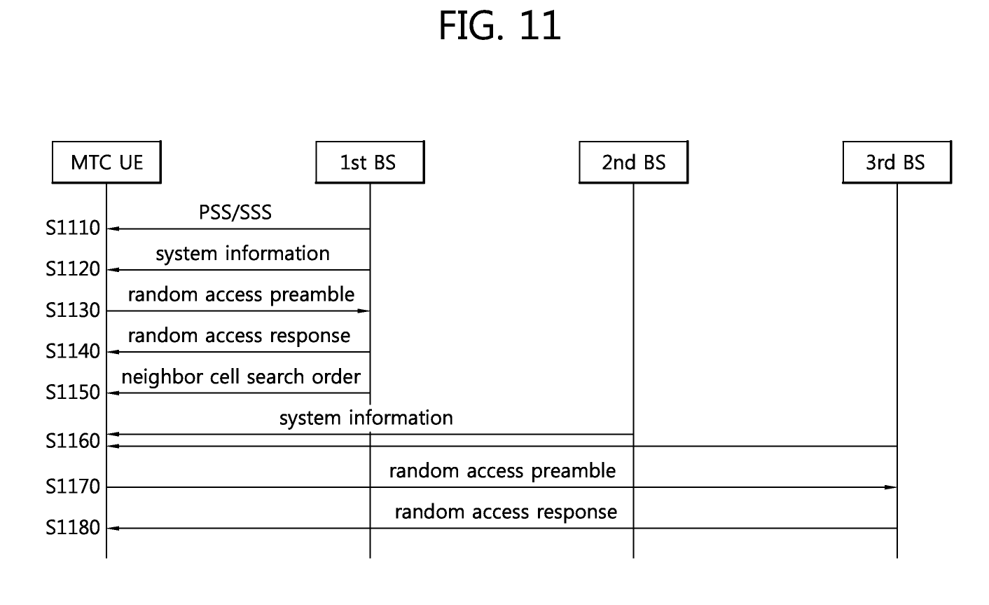

FIG. 11 shows a neighbor cell search and establishment scenario of MTC UE in accordance with an embodiment of the present invention.

The MTC UE receives a PSS/SSS from a BS at step S1110. The MTC UE performs a synchronization procedure with the BS based on the PSS/SSS. The MTC UE detects the SSS and detects radio frame timing and obtains a cell ID based on the detected SSS. The MTC UE detects the PSS and detects slot timing and obtains a physical layer ID based on the detected PSS.

The MTC UE receives system information from a first BS through a PBCH at step S1120. As described above, the PBCH may include information regarding whether or not the first BS supports MTC UE. In the scenario of FIG. 11, it is assumed that the first BS supports MTC UE.

The MTC UE transmits a random access preamble to the first BS at step S1130. As described above, the random access preamble may be a dedicated random access preamble for MTC UE.

In response to the random access preamble, the first BS transmits a random access response to the MTC UE at step S1140. In response to the random access response, the MTC UE can transmit a scheduled message to the first BS based on an UL grant within the random access response.

Meanwhile, neighbor cell searches may be performed depending on the necessity of MTC UE and/or a BS. If MTC UE is fixed, neighbor cell searches can be performed only at the request of a serving BS. Referring back to FIG. 11, the first BS transmits a message, indicating that the MTC UE should perform neighbor cell searches, to the MTC UE at step S1150.

The MTC UE receives pieces of system information from second and third BSs through respective PBCHs at step S1160. The PBCHs can include pieces of information regarding whether or not the second and the third BSs support MTC UE. In the scenario of FIG. 11, it is assumed that the second BS does not support MTC UE, and the third BS supports MTC UE.

The MTC UE transmits a random access preamble to a BS supporting MTC UE. That is, in the scenario of FIG. 11, the MTC UE transmits a random access preamble to the third BS at step S1170. The random access preamble may be a dedicated random access preamble for MTC UE.

In response to the random access preamble, the third BS transmits a random access response to the MTC UE at step S1180. In response to the random access response, the MTC UE can transmit a scheduled message to the third BS based on an UL grant within the random access response.

In accordance with the aforementioned scenario, MTC UE can receive a PBCH including information regarding whether or not a corresponding BS supports MTC UE, select BS(s) supporting MTC UE from a plurality of BSs as candidate BS(s). If the number of candidate BSs is plural, the MTC UE can select a first cell satisfying a threshold value during initial setup, thereby being capable of simplifying the cell selection and reducing energy consumption.

Meanwhile, as described above, in response to the dedicated random access preamble received from the MTC UE, the BS may determine whether or not to accept the request of the MTC UE depending on its capabilities. For example, in the scenario of FIG. 11, if the capabilities of the third BS are limited, the third BS can inform the MTC UE that the third BS no longer supports the MTC UE through the random access response. In this case, the MTC UE searches for and selects another BS capable of supporting the MTC UE.

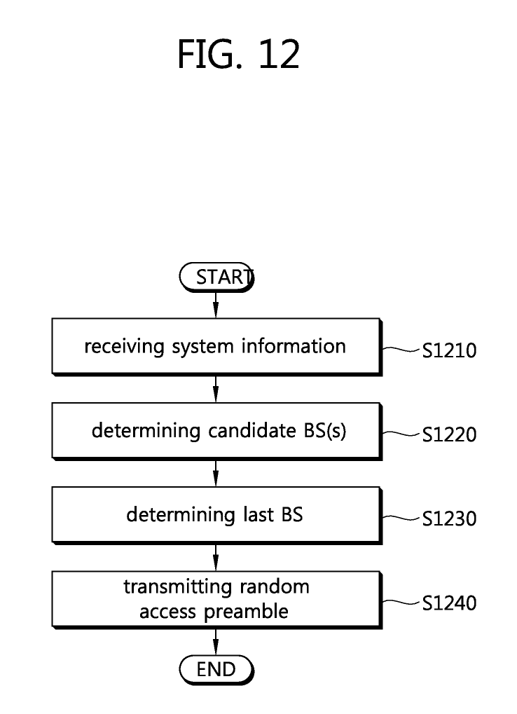

FIG. 12 is a flowchart illustrating a connection establishment method for MTC UE in accordance with an embodiment of the present invention.

The MTC UE receives system information from at least one neighbor BS through a PBCH at step S1210. As described above, the system information can include information regarding whether or not a BS supports MTC UE.

For example, the system information can include a field indicating whether or not the BS supports MTC UE.

For example, the system information can include an MTC subframe pattern index. The MTC subframe pattern index indicates a subframe in which the MTC UE transmits a random access preamble.

The MTC UE performs cell searches based on the system information. The MTC UE determines one or more BSs supporting MTC UE, from a plurality of BSs, as candidate BSs at step S1220.

The MTC UE determines the last BS of the one or more candidate BSs at step S1230. The MTC UE may determine the last BS based on the intensity of the DL signal of a candidate BS.

For example, the MTC UE may determine a candidate BS having the greatest intensity of a DL signal as the last BS.

For example, the MTC UE may determine a candidate BS, first searched for from among candidate BSs in each of which the intensity of a DL signal is greater a specific threshold value, as the last BS. Accordingly, the cell selection can be simplified, and energy consumed by MTC UE can be reduced.

The MTC UE transmits random access preamble to the last BS at step S1240. The random access preamble can be an MTC-dedicated preamble transmitted in a narrower bandwidth than a random access preamble transmitted by existing UE.

For example, existing UE transmits a random access preamble using a 20-MHz bandwidth, whereas MTC UE can transmit a random access preamble using a bandwidth narrower than the 20-MHz bandwidth. That is, the MTC UE can transmit a random access preamble through a PRACH configured to a bandwidth narrower than the 20-MHz bandwidth. In contrast, a PBCH in which system information is received is configured to the 20-MHz bandwidth.

If an MTC subframe pattern index is received at step S1210, the MTC UE transmits a random access preamble in a subframe indicated by the MTC subframe pattern index.

Through the aforementioned method, a BS can rapidly inform MTC UE of information regarding whether or not the BS supports MTC UE, and the MTC UE can search for a BS to be accessed thereto rapidly and efficiently based on the information. Furthermore, the BS can obtain information regarding the specifications of UE from the MTC UE, for example, information regarding whether or not the MTC UE has lower specifications than common UE so that the corresponding MTC UE can use specific resources and codes.

Meanwhile, the present invention also proposes a Radio Resource Management (RRM) method and a channel measurement/estimation method for MTC UE in an LTE system. In accordance with a method to be described later, an RRM method and a channel measurement/estimation method defined in an existing LTE system can be more simplified.

In order to implement cheap hardware having low complexity, it is expected that MTC UE will use a single rank, 1 Radio Access Technology (RAT), Single Input Single Output (SISO), or Multiple Input Multiple Output (MIMO) supporting only transmit diversity. That is, it is expected that MTC UE will support only transmission mode 1 or 2 defined in an LTE system. Accordingly, MTC UE does not need to use MIMO-related parameters, such as a PMI, a Precoding Type Indicator (PTI), and an RI.

Furthermore, MTC UE may transmit and receive data intermittently and use only a limited bandwidth. If MTC UE has a long sleep cycle, the MTC UE enters an RRC_IDLE state whenever the sleep cycle is started and occasionally wakes up in order to process paging data or UL data that are pending. Whenever the MTC UE wakes up, a random access procedure is performed; the MTC UE chiefly uses aperiodic CSI triggered by a random access response grant.

It is preferred by taking the aforementioned features into consideration; MTC UE do not transmit MIMO-related parameters, such as a PMI, a PTI, and an RI and aperiodic CSI reports a wideband CQI. The following table shows a changed PUSCH CSI report mode.

TABLE 5
[Table] CQI and PMI Feedback Types
for PUSCH CSI reporting Modes

| | | PMI Feedback Type | | |
|---|---|---|---|---|
| | | No PMI | Single PMI | Multiple PMI |
| PUSCH | Wideband | Mode 1-0 | | Mode 1-2 |
| CQI | (wideband CQI) | | | |
| Feedback | UE Selected | Mode 2-0 | | Mode 2-2 |
| Type | (subband CQI) | | | |
| | Higher Layer- | Mode 3-0 | Mode 3-1 | |
| | configured | | | |
| | (subband CQI) | | | |

Transmission mode 1: Modes 1-0, 2-0, 3-0
Transmission mode 2: Modes 1-0, 2-0, 3-0

Mode 1-0 (wideband feedback): MTC UE can report one wideband CQI calculated by assuming transmission through a set S subband.

Furthermore, MTC UE may not perform a periodic CSI report although the periodic CSI report has been configure. That is, the MTC UE may be configured to perform a CSI report only when it receives an aperiodic CSI report from a BS through a paging message. If the aperiodic CSI report is received through the paging message, the MTC UE can perform a CSI report along with the transmission of ACK/NACK to the paging message or UL transmission triggered by the paging message although an additional CSI request is not present. If both the transmission of ACK/NACK and the CSI report are performed, PUCCH format 2 series can be used. In this case, the MTC UE may assume that CSI is multiplexed with the ACK/NACK and transmitted through a specific PUSCH.

Meanwhile, in an LTE system, a moving pattern and a traffic pattern have been designed by chiefly taking a dynamic user into consideration. In contrast, MTC UE is characterized in that the MTC UE has a specific moving pattern or the MTC UE is fixed to the same place like a smart metering or highway traffic monitoring MTC device. Furthermore, MTC UE is characterized in that it performs periodic data transmission. If MTC UE is fixed, a channel condition is not suddenly changed for a long time. Accordingly, it is preferred that a measurement report be performed at a long interval. In this case, MTC UE can maintain RRC_Connected mode having a long DRX cycle and estimate a channel using a periodic CSI measurement report.

Furthermore, the present invention proposes a new transmission mode for UE having a static and intermittent transmission pattern, for example, MTC UE.
Transmission mode 10: single BS antenna mode having features of static channel estimation/measurement report

By configuring a new transmission mode, a BS and UE can expect that a measurement report result will be similar to a previous measurement report result except a specific situation (e.g., the occurrence of interference from a neighbor cell). Accordingly, if a measurement report result is suddenly changed, UE and a BS can instruct to check “whether or not the location of the UE has been changed or whether or not there is an unexpected change”. Here, fixed UE can periodically perform a CSI report in RRC_Connected mode and may report only the CQI of a selected subband.

Furthermore, by configuring a new transmission mode, fixed UE can be used for various purposes. Since channel estimation for fixed UE is stable, the channel estimation can be used to detect a change in the physical location of the fixed UE. That is, a physical security/monitoring capability can be provided to the fixed UE. In accordance with the method, there is an advantage in that the consumption of the battery of UE can be reduced as compared with a scheme such as a Global Positioning System (GPS), a location detection technology based on a network used to detect a physical location.

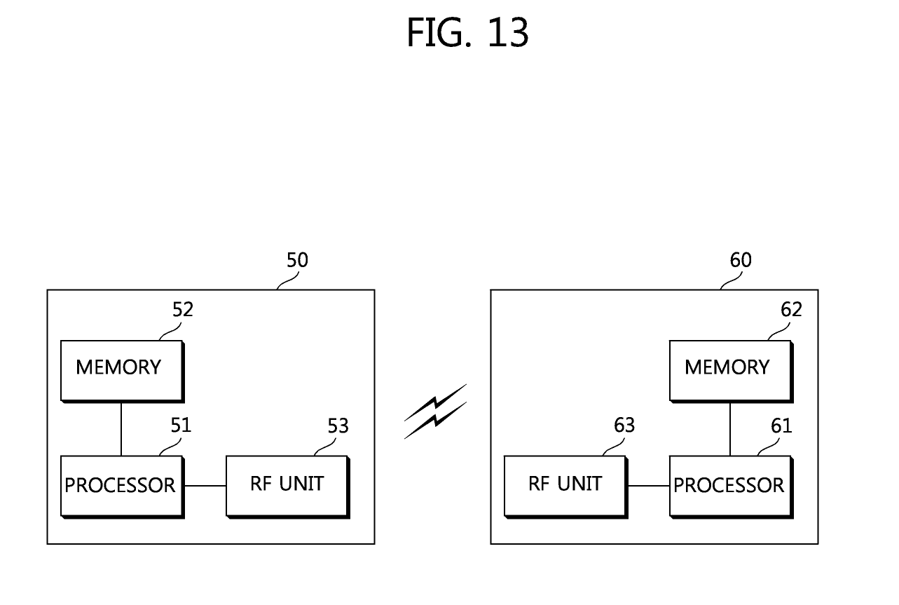

FIG. 13 is a block diagram of a wireless communication system in which the embodiments of the present invention are implemented.

A BS 50 includes a processor 51, a memory 52, and a Radio Frequency (RF) unit 53. The memory 52 is connected to the processor 51 and configured to store various pieces of information for driving the processor 51. The RF unit 53 is connected to the processor 51 and configured to transmit and/or receive radio signals. The processor 51 implements the proposed functions, processes, and/or methods. In the aforementioned embodiments, the operation of the BS can be implemented by the process 51.

UE 60 includes a processor 61, a memory 62, and an RF unit 63. The memory 62 is connected to the processor 61 and configured to store various pieces of information for driving the processor 61. The RF unit 63 is connected to the processor 61 and configured to transmit and/or receive radio signals. The processor 61 implements the proposed functions, processes, and/or methods. In the aforementioned embodiments, the operation of the UE can be implemented by the process 61.

The processor may include Application-Specific Integrated Circuits (ASICs), other chipsets, logic circuits and data processors. The memory may include Read-Only Memory (ROM), Random Access Memory (RAM), flash memory, memory cards, storage media and/or other storage devices. When the embodiment is implemented in software, the above scheme may be implemented into a module (process or function) that performs the above functions. The module may be stored in the memory and executed by the processor. The memory may be placed inside or outside the processor and functionally coupled to the processor by a variety of well-known means.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

1. A connection establishment method for a Machine Type Communication (MTC) User Equipment (UE) in a wireless communication system, comprising:
receiving, by a MTC UE, system information from at least one neighbor Base Station (BS), the system information including information regarding whether or not the at least one BS supports MTC UE;
determining, by the MTC UE, at least one candidate BS based on the system information, the at least one candidate BS supporting the MTC UE;
determining, by the MTC UE, a last BS based on an intensity of a signal from the at least one candidate BS; and
sending, by the MTC UE, a random access preamble to the last BS.

2. The method of claim 1, wherein the system information includes an MTC subframe pattern index indicative of a subframe in which the random access preamble is transmitted.

3. The method of claim 1, wherein the random access preamble is an MTC-dedicated preamble.

4. The method of claim 3, wherein the random access preamble is transmitted in a bandwidth narrower than a bandwidth in which the system information is received.

5. The method of claim 4, wherein:
the system information is received in a bandwidth of 20 MHz, and
the random access preamble is transmitted in a bandwidth narrower than 20 MHz.

6. The method of claim 5, wherein:
the system information is received via a physical broadcast channel (PBCH), and
the random access preamble is transmitted via a physical random access channel (PRACH).

7. The method of claim 1, wherein the last BS is a BS having a strongest intensity of a signal, from among the at least one candidate BS.

8. The method of claim 1, wherein the last BS is a BS first searched for from among the at least one candidate BS in each of which the intensity of the signal is greater than a predetermined threshold.

9. A Machine Type Communication (MTC) User Equipment (UE) in a wireless communication system, comprising:
a Radio Frequency (RF) unit configured to transmit and receive radio signals; and
a processor connected to the RF unit, the processor is configured to:
receive system information from at least one neighbor Base Station (BS), the system information including information regarding whether or not the at least one BS supports MTC UE;
determine at least one candidate BS based on the system information, the at least one candidate BS supporting the MTC UE;
determine a last BS based on an intensity of a signal from the at least one candidate BS; and
send a random access preamble to the last BS.

10. The UE of claim 9, wherein the system information comprises an MTC subframe pattern index indicative of a subframe in which the random access preamble is transmitted.

11. The UE of claim 10, wherein the random access preamble is transmitted in a bandwidth narrower than a bandwidth in which the system information is received.

12. The UE of claim 11, wherein:
the system information is received in a bandwidth of 20 MHz, and
the random access preamble is transmitted in a bandwidth narrower than 20 MHz.

13. The UE of claim 9, wherein the last BS is a BS having a strongest intensity of a signal, from among the at least one candidate BS.
